(19) United States
(12) Patent Application Publication
(10) Pub. No.: US 2017/0304784 A1
(43) Pub. Date: Oct. 26, 2017

(54) GAS DISSOLUTION ASSEMBLIES FOR BATCH BEVERAGES

(71) Applicant: Cornelius, Inc., St. Paul, MN (US)

(72) Inventor: Tomasz K. Kasprzycki, Carpentersville, IL (US)

(73) Assignee: Cornelius, Inc., St. Paul, MN (US)

(21) Appl. No.: 15/138,643

(22) Filed: Apr. 26, 2016

(51) Int. Cl. B01F 3/04; B01F 15/00

(52) U.S. Cl. CPC B01F 3/04808; B01F 15/00779; B01F 2015/00084; B01F 2003/049

(57) ABSTRACT

A batch gasification assembly comprises a pressure vessel having an open end and being configured to contain a beverage to be carbonated and a flexible seal that covers the open end of the pressure vessel. A closure mechanism for the pressure vessel comprises a retainer configured to receive and retain the open end of the pressure vessel, a top cap, and an over-center clamping mechanism that is configured to clamp the top cap onto the open end of the pressure vessel so that the flexible seal member is sandwiched between the top cap and the open end of the pressure vessel.

### FIELD

The present disclosure relates to gas dissolution assemblies for batch beverages.

### BACKGROUND

The following U.S. patent and U.S. patent application are incorporated herein by reference in entirety.

U.S. Pat. No. 9,114,368 discloses a batch carbonation apparatus having a housing that defines a vessel cavity. The housing includes an agitation mechanism. The pressure vessel includes a cap that has a CO2 inlet and a CO2 outlet is provided. The pressure vessel also includes a seal. The pressure vessel is moveable into an out of the vessel cavity. A locking mechanism is provided and is attached to the agitation mechanism to removably lock the cap and seal relative to the pressure vessel. A CO2 source is connected to a plurality of valves where each valve has a differing pressure. A selection toggle is attached to the housing. A control mechanism is coupled to the plurality of valves. A user selects a desired carbonation level using the selection toggle and CO2 is introduced to the pressure vessel at a specified pressure wherein the agitation mechanism agitates liquid within the pressure vessel forming a carbonated beverage having a selected carbonation level. Also disclosed is a process of forming a carbonated beverage in a batch.

U.S. Patent Application Serial No. 2014/0302212 discloses a carbonation apparatus that includes a pressure vessel having a cap with a gas inlet and a gas outlet. The carbonation device also includes a seal. The seal includes a labyrinth preventing contact of a liquid within the pressure vessel with the cap during a carbonation process. A locking mechanism removably locks the cap and seal and antifoam device relative to the pressure vessel.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some examples, a gas dissolution assembly includes a pressure vessel having an open end. The pressure vessel is configured to contain a beverage into which a gas is dissolved. A flexible seal covers the open end of the pressure vessel. A closure mechanism for the pressure vessel comprises a retainer configured to receive and retain the open end of the pressure vessel, a top cap, and an over-center clamping mechanism that is configured to clamp the top plate onto the open end of the pressure vessel so that the flexible seal member is sandwiched between the top cap and the open end of the pressure vessel.

In some examples, a gas dissolution assembly includes a pressure vessel having an open end. The pressure vessel is configured to contain a beverage. A closure mechanism is for the pressure vessel. The closure mechanism includes a top cap configured to couple with the open end of the pressure vessel and a clamping mechanism having a cam configured to rotate about a pivot axis. Rotation of the cam about the pivot axis in a first direction cams the top cap towards the first end of the pressure vessel such that the top cap couples to the open end. Opposite rotation of the cam about the pivot axis in a second direction cams the top cap away from the open end of the pressure vessel such that the top cap uncouples from the top end of the pressure vessel.

### BRIEF DESCRIPTION OF THE DRAWINGS

The present disclosure is described with reference to the following Figures. The same numbers are used throughout the Figures to reference like features and like components.

FIG. 1 is an example gas dissolution machine for batch beverages.

FIG. 2 is an example gas dissolution assembly.

FIG. 3 is an exploded view of the gas dissolution assembly of FIG. 2.

FIG. 4 is a cross section of the gas dissolution assembly of FIG. 2, including a pressure vessel being moved into a closure mechanism.

FIG. 5 is a cross section of the gas dissolution assembly of FIG. 2, where the pressure vessel is vertically supported by a semi-peripheral channel.

FIG. 6 is a cross section of the gas dissolution assembly of FIG. 2, depicting a clamping mechanism sandwiching a flexible seal between a top cap and the pressure vessel to create a fluid-tight connection.

### DETAILED DESCRIPTION

In the present description, certain terms have been used for brevity, clarity and understanding. No unnecessary limitations are to be inferred therefrom beyond the requirement of the prior art because such terms are used for descriptive purposes only and are intended to be broadly construed. The different apparatuses described herein may be used alone or in combination with other apparatuses. Various equivalents, alternatives and modifications are possible within the scope of the appended claims.

The present disclosure is described herein using several definitions, as set forth below and throughout the application. Unless otherwise specified or indicated by context, the terms “a”, “an”, and “the” mean “one or more.” For example, “a compound” should be interpreted to mean “one or more compounds.”

As used herein, “about,” “approximately,” “substantially,” and “significantly” will be understood by persons of ordinary skill in the art and will vary to some extent on the context in which they are used. If there are uses of these terms which are not clear to persons of ordinary skill in the art given the context in which they are used, “about” and “approximately” will mean plus or minus ≦10% of the particular term and “substantially” and “significantly” will mean plus or minus >10% of the particular term.

As used herein, the terms “include” and “including” have the same meaning as the terms “comprise” and “comprising” in that these latter terms are “open” transitional terms that do not limit claims only to the recited elements succeeding these transitional terms. The term “consisting of,” while encompassed by the term “comprising,” should be interpreted as a “closed” transitional term that limits claims only to the recited elements succeeding this transitional term. The term “consisting essentially of,” while encompassed by the term “comprising,” should be interpreted as a “partially closed” transitional term which permits additional elements succeeding this transitional term, but only if those additional elements do not materially affect the basic and novel characteristics of the claim.

Through research and experimentation, the present inventors have developed a machine configured to quickly and effectively dissolve a gas in a beverage. The machine can dissolve gas (e.g. nitrogen, CO2) into the beverage, and the concentration of a gas in the beverage can be adjusted to various levels. As described in the above-incorporated U.S. patent application and U.S. patent, a user can place a finished beverage (including but not limited to water, flavoring syrups, and additives) into a pressure vessel and pressurize the beverage with a gas such that the gas saturates and dissolves into the beverage. The pressure vessel can be agitated to reduce the time needed to dissolve the gas into the beverage.

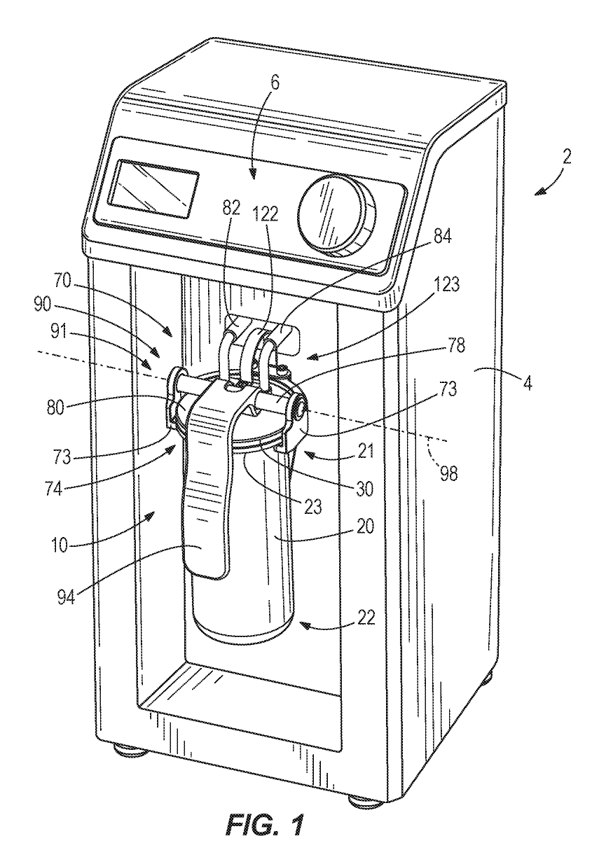

FIGS. 1-6 depict examples of gas dissolution assemblies for dissolving gases into beverages. The examples shown can be utilized in combination with the machines disclosed in the above-incorporated U.S. patent application and U.S. patent.

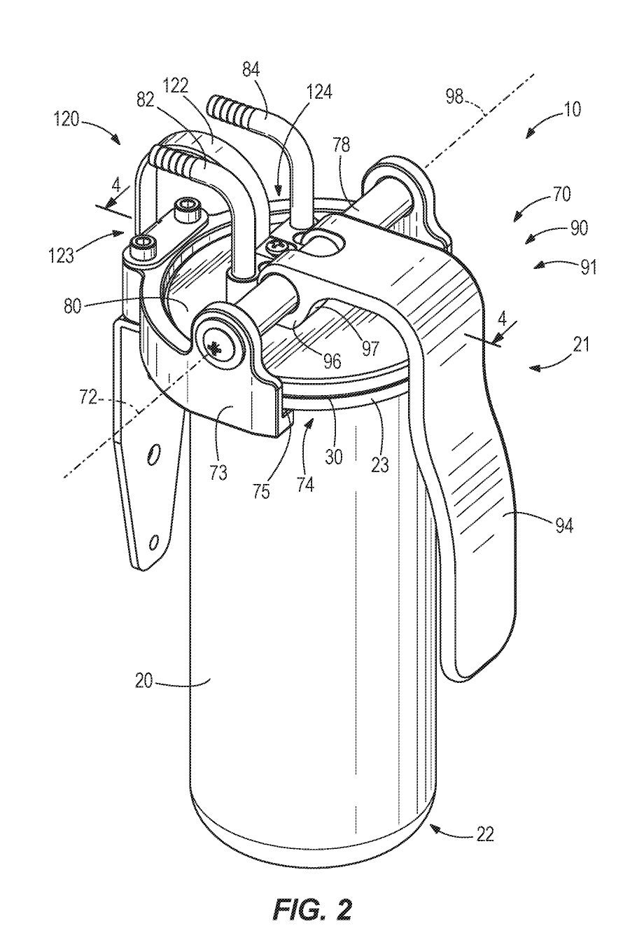

Referring to FIG. 1, a beverage machine 2 includes a housing 4, a user input device 6 configured to receive an input from a user, and a gas dissolution assembly 10 configured to dissolve a gas into a batch or single serve beverage. FIGS. 2-6 depict the gas dissolution assembly 10 in greater detail.

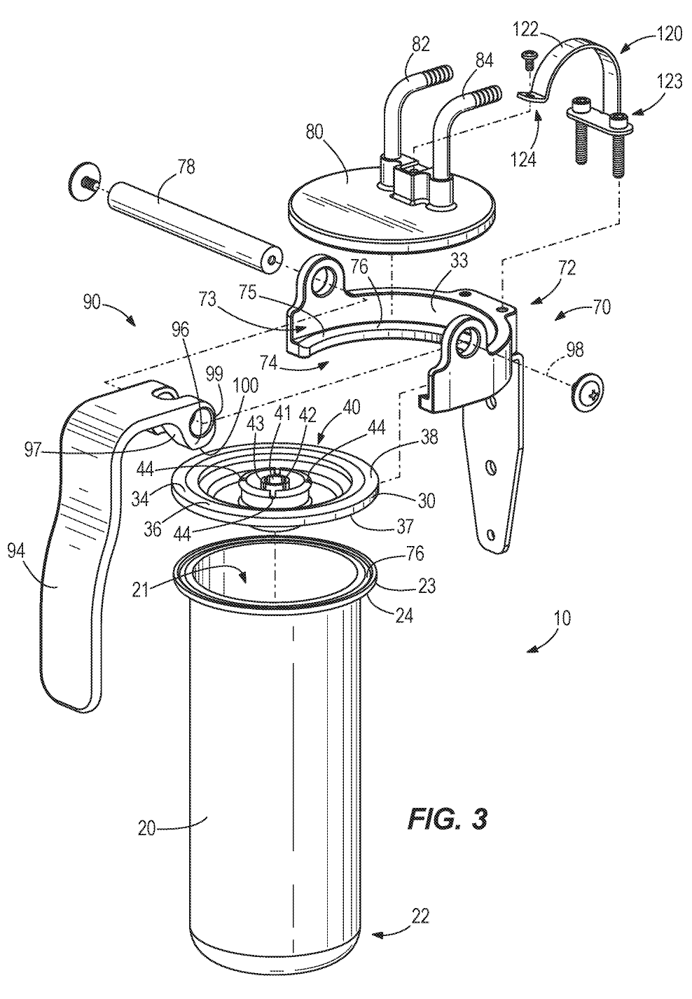

The gas dissolution assembly 10 includes a container or pressure vessel 20 configured to receive and contain the beverage into which the gas will be dissolved. Referring to FIG. 3, the pressure vessel 20 has an open end 21 and an opposite closed end 22. A peripheral flange 23 extends radially and peripherally around the open end 21. The peripheral flange 23 has a lower surface 24.

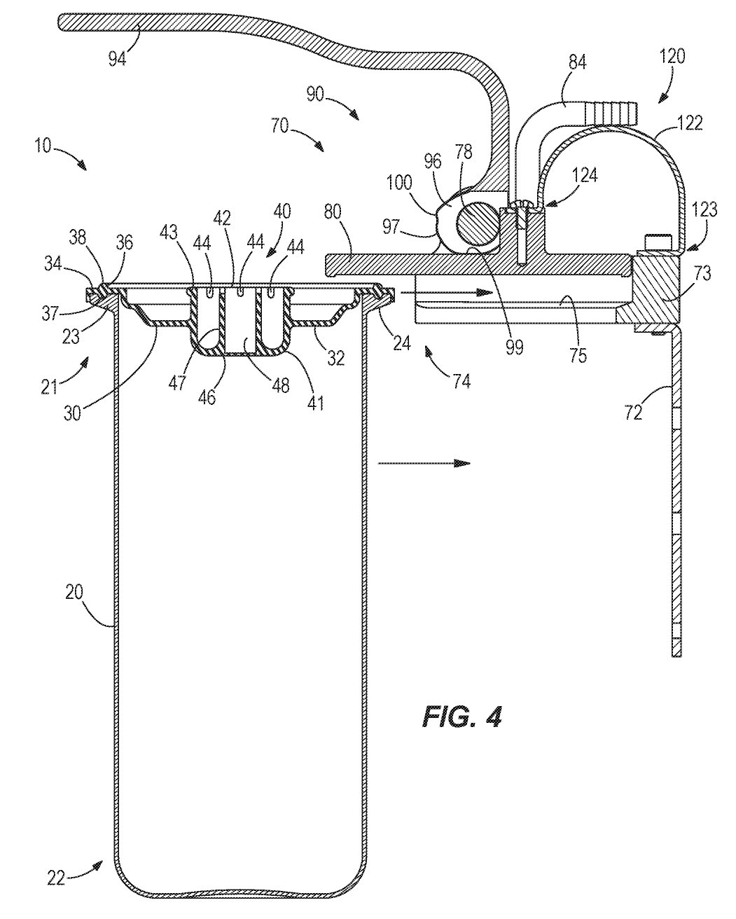

Referring to FIG. 4, a flexible seal 30 is configured to cover the open end 21 of the pressure vessel 20. The flexible seal 30 includes a flexible membrane 32 constructed in accordance with the embodiments disclosed in the above-incorporated U.S. patent application. As described in the above-incorporated U.S. patent application, gas to be dissolved in the beverage passes through at least air flow passage 48 in the flexible membrane 32 and into the pressure vessel 20. The flexible membrane 32 includes a peripheral sealing lip 34 and a central portion 40 in which the at least one air flow passage 48 is formed. The peripheral sealing lip 34 includes a peripheral seal bead 36 having a lower portion 37 and an upper portion 38. The central portion 40 includes a central support column 41 having an open top end 42 and a sunken central portion 46 in which the central support column 41 is disposed. The open top end 42 of the central support column 41 has a sealing bead 43 and defines a plurality of radial slots 44. A central baffle member 47 extends upwardly from the sunken central portion 46 such that that central baffle member 47 and the central support column 41 together define a circuitous flow path for gas to flow to and from the at least one air flow passage. The central support column 41 and the central baffle member 47 are concentrically aligned. Reference is made to the above-incorporated U.S. patent application for further description.

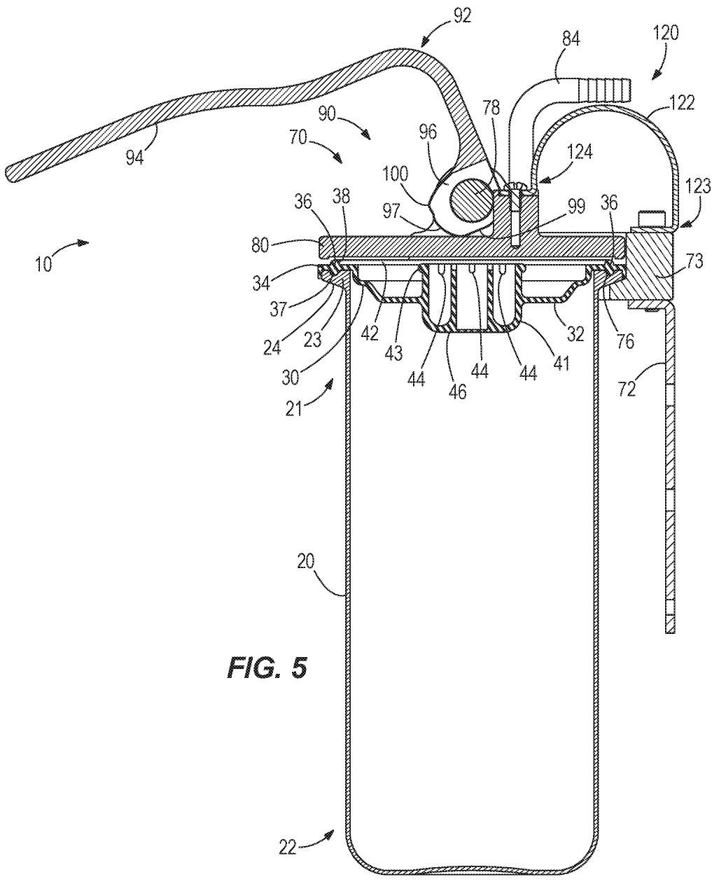

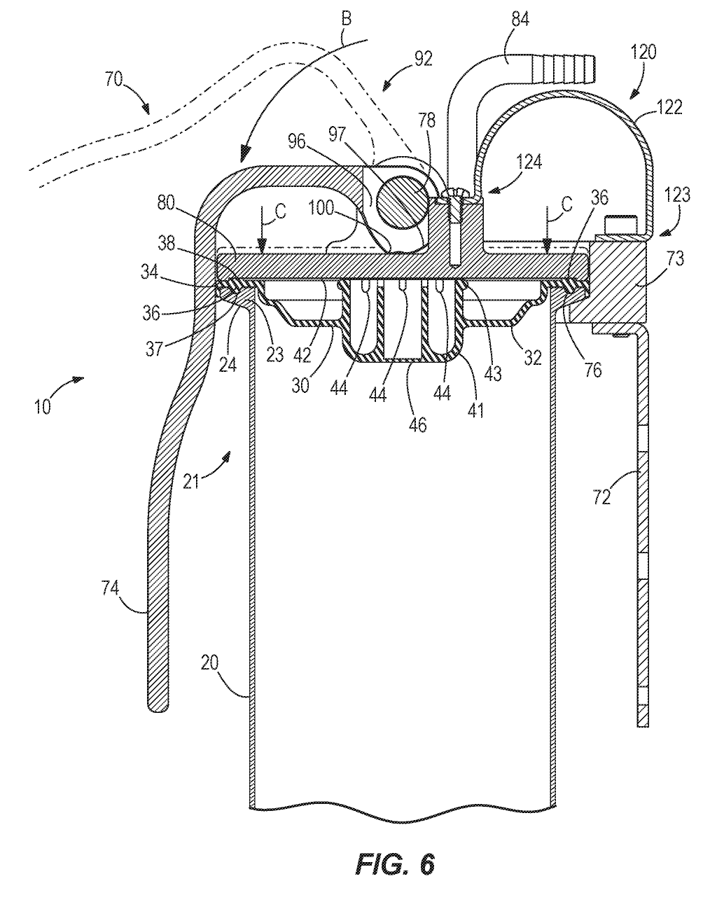

Referring to FIG. 3, the gas dissolution assembly 10 includes a unique closure mechanism 70 having a retainer 72, a top cap 80, and a clamping mechanism 90. The clamping mechanism 90 is an over-center clamping mechanism 90 that is configured to efficiently and effectively clamp the top cap 80 onto the open end 21 of the pressure vessel 20 such that the flexible seal 30 is sandwiched between the top cap 80 and the open end 21 of the pressure vessel 20 (see FIG. 2). The over-center clamping mechanism 90 is movable into and between a clamped position (see FIGS. 2 and 6) wherein the over-center clamping mechanism 90 clamps the top cap 80 onto the open end 21 of the pressure vessel 20 and an unclamped position (see FIGS. 4 and 5) wherein the top cap 80 is unclamped from the open end 21 of the pressure vessel 20 so that the pressure vessel 20 can be removed from the retainer 72 (see FIGS. 4 and 5). A gas inlet 82 and a gas outlet 84 extend through the top cap 80 and facilitate flow of gas to and from the pressure vessel 20 via the circuitous path and the air flow passage 48 in the flexible seal 30.

The over-center clamping mechanism 90 comprises a lever 94 and a cam 96 connected to the lever 94. Upon manual rotation of the lever 94 about a pivot axis 98 in a first direction (see motion arrow B shown in FIG. 6 depicting movement of the lever 94), the cam 96 cams the top cap 80 onto the open end 21 of the pressure vessel 20 (see motion arrows C shown in FIG. 6 depicting movement of the top cap 80 as the cam 96 rotates). Upon opposite manual rotation of the lever 94 about the pivot axis 98 in a second direction, a resilient member 120 (to be described further herein) is allowed to force the top cap 80 out of engagement with the flexible seal 30. The cam 96 comprises an eccentric outer surface 97 that engages the top cap 80. The eccentric outer surface 97 includes a first flattened surface 99 and a second flattened surface 100 (see FIGS. 4 and 5). The first flattened surface 99 is configured to contact the top cap 80 when the closure mechanism 70 is in the unclamped position (see FIGS. 4 and 5) such that the cam 96 resists rotation and the lever 94 maintains a substantially horizontal orientation which allows the user to operate the closure mechanism 70 with one hand. The closure mechanism 70 is moved from the unclamped position to the clamped position (see FIG. 6) when an external force is applied to the lever 94 (i.e. a user manually grasps and pulls the lever 94 downwardly with one hand) which causes the cam 96 to rotate about the pivot axis P such that the cam 96 cams the top cap 80 onto the open end 21 of the pressure vessel 20. The second flattened surface 100 is configured to stop rotation of the cam 96 about the pivot axis 98 when the closure mechanism 70 is in the clamped position (see FIG. 6) (i.e. the lever 94 is in a substantially vertical orientation). The cam 96 is supported on and pivotable with cross shaft 78 which is coupled on the retainer 72. The cross shaft 78 thus extends along the pivot axis 98 for the cam 96. In other examples, the cross shaft 78 can be a stationary shaft and the cam 96 can rotate about the stationary shaft.

Referring to FIG. 3, the retainer 72 is mounted to the housing 4 and is configured to receive and retain the open end 21 of the pressure vessel 20. The retainer 72 includes a semi-peripheral channel 73 having an open side 74 that is configured to receive the peripheral flange 23 of the pressure vessel 20. The semi-peripheral channel 73 includes a support surface 75 configured such that the peripheral flange 23 of the pressure vessel 20 is supported on the support surface 75 when the pressure vessel 20 is retained by the retainer 72. The peripheral flange 23 includes a ring groove 76 configured to receive the peripheral seal bead 36 of the peripheral sealing lip 34 of the flexible seal 30 such that the peripheral seal bead 36 nests in the ring groove 76 when the over-center clamping mechanism 90 clamps the top cap 80 onto the open end 21 of the pressure vessel 20. Specifically, the lower portion 37 of the peripheral seal bead 36 nests in the ring groove 76 and the upper portion 38 of the peripheral seal bead 36 forms a seal against the top cap 80.

The flexible seal 30 is sandwiched between the top cap 80 and the support surface 75 of the semi-peripheral channel 73 when the over-center clamping mechanism 90 clamps the top cap 80 onto the open end 21 of the pressure vessel 20 (see FIGS. 2 and 6). The central support column 41 of the flexible membrane 32 engages the top cap 80 when the over-center clamping mechanism 90 clamps the top cap 80 onto the open end 21 of the pressure vessel 20. The sealing bead 43 of the open top end 42 of the central support column 41 engages the top cap 80 and the radial slots 44 of the seal bead 43 allow flow of gas radially into and out of the central support column 41.

The gas dissolution assembly 10 also includes a resilient member 120 that tends to force the top cap 80 out of engagement with the flexible seal 30. In the illustrated examples, the resilient member 120 comprises a leaf spring 122 having a first end 123 connected to the retainer 72 and a second end 124 connected to a central location of the top cap 80. The type and configuration of the resilient member 120 can vary from that shown. In other examples, the resilient member 120 can include coil springs, gas springs, elastic material, and/or the like.

FIGS. 4-6 depict an example operational sequence for the gas dissolution assembly 10. FIG. 4 depicts the flexible seal 30 covering the open end 21 of the pressure vessel 20. The flexible seal 30 is made of elastic material such that the flexible seal 30 covers and is held in the open end 21. The pressure vessel 20 and the flexible seal 30 are configured to easily slide into the closure mechanism 70 such that the lower surface 24 of the peripheral flange 23 slides along the semi-peripheral channel 73 and on the support surface 75 (see motion arrow A shown in FIG. 4 depicting movement of the pressure vessel 20 and the flexible seal 30 into the closure mechanism 70).

Referring to FIG. 5, the pressure vessel 20 and the flexible seal 30 are positioned in the closure mechanism 70 (as described with reference to FIG. 4 above) such that the pressure vessel 20 and the flexible seal 30 are vertically supported by the semi-peripheral channel 73. The lower surface 24 of the peripheral flange 23 of the pressure vessel 20 contacts and/or rests on support surface 75 of the semi-peripheral channel 73.

FIG. 6 depicts the clamping mechanism 90 of the closure mechanism 70 moving (see motion arrows B and C) from the unclamped position (the lever 94 and top cap 80 are depicted by dashed lines when in the unclamped position) to the clamped position (the lever 94 and the top cap 80 are depicted by solid lines when in the clamped position).

As discussed herein above, the present disclosure includes examples of gas dissolution assemblies 10. In certain examples, a gas dissolution assembly 10 includes a pressure vessel 20 having an open end 21 and being configured to contain a beverage into which a gas is dissolved. A flexible seal 30 covers the open end 21 of the pressure vessel 20, and closure mechanism 70 closes the pressure vessel 20. The closure mechanism 70 includes a retainer 72 configured to receive and retain the open end 21 of the pressure vessel 20, a top cap 80 and an over-center clamping mechanism 90 that is configured to clamp the top cap 80 onto the open end 21 of the pressure vessel 20 so that the flexible seal 30 is sandwiched between the top cap 80 and the open end 21 of the pressure vessel 20.

In certain examples, the gas dissolution assembly 10 includes the pressure vessel 20 having an open end 21 and a closure mechanism 70 for the pressure vessel 20. The pressure vessel 20 is configured to contain the beverage. The closure mechanism 70 has a top cap 80 which is configured to couple with the open end 21 of the pressure vessel 20 and a cam 96 configured to rotate about a pivot axis 98. Rotation of the cam 96 about the pivot axis 98 in a first direction continuously cams the top cap 80 towards the open end 21 of the pressure vessel 20 such that the top cap 80 couples to the open end 21. Opposite rotation of the cam 96 about the pivot axis 98 in a second direction continuously cams the top cap 80 away from the open end 21 of the pressure vessel 20 such that the top cap 80 uncouples from the open end 21 of the pressure vessel 20.

What is claimed is:

1. A gas dissolution assembly comprising:
a pressure vessel having an open end and being configured to contain a beverage into which a gas is dissolved;
a flexible seal that covers the open end of the pressure vessel; and
a closure mechanism for the pressure vessel, the closure mechanism comprising:
a retainer configured to receive and retain the open end of the pressure vessel; and
a top cap and an over-center clamping mechanism that is configured to clamp the top cap onto the open end of the pressure vessel so that the flexible seal member is sandwiched between the top cap and the open end of the pressure vessel.

2. The gas dissolution assembly according to claim 1, wherein the pressure vessel comprises a peripheral flange at the open end and wherein the retainer comprises a semi-peripheral channel having an open side that is configured to receive the peripheral flange of the pressure vessel.

3. The gas dissolution assembly according to claim 2, wherein the semi-peripheral channel comprises a support surface and wherein the peripheral flange has a lower surface that is supported on the support surface when the pressure vessel is retained by the retainer.

4. The gas dissolution assembly according to claim 3, wherein the flexible seal is sandwiched between the top cap and the peripheral flange of the pressure vessel when the over-center clamping mechanism clamps the top cap onto the open end of the pressure vessel.

5. The gas dissolution assembly according to claim 4, wherein the flexible seal comprises a flexible membrane having a peripheral sealing lip and a central portion in which at least one air flow passage is formed and configured to allow gas to pass through the flexible membrane and into the pressure vessel.

6. The gas dissolution assembly according to claim 5, wherein the peripheral flange comprises a ring groove and wherein the peripheral sealing lip comprises a peripheral seal bead that is nested in the ring groove when the over-center clamping mechanism clamps the top cap onto the open end of the pressure vessel.

7. The gas dissolution assembly according to claim 6, wherein the peripheral seal bead comprises a lower portion that is nested in the ring groove and an upper portion that forms a seal against the top cap.

8. The gas dissolution assembly according to claim 5, wherein central portion has central support column and a sunken central portion in which the central support column is disposed, the central support column having an open top end that engages the top cap when the over-center clamping mechanism clamps the top cap onto the open end of the pressure vessel.

9. The gas dissolution assembly according to claim 8, wherein the open top end of the central support column has a sealing bead that engages with the top cap, wherein the sealing bead defines a plurality of radial slots therein allowing flow of radially into and out of the central support column.

10. The gas dissolution assembly according to claim 9, further comprising a central baffle member that extends upwardly from the sunken central portion such that the central baffle member and central support column together define a circuitous flow path for to flow to and from the at least one air flow passage.

11. The gas dissolution assembly according to claim 10, wherein the central support column and the central baffle member are concentrically aligned.

12. The gas dissolution assembly according to claim 1, further comprising a gas inlet through the top cap and a gas outlet through the top cap.

13. The gas dissolution assembly according to claim 1, further wherein the over-center clamping mechanism is movable into and between clamped position wherein the over-center clamping mechanism clamps the top cap onto the open end of the pressure vessel and an unclamped position wherein the top cap is unclamped from the open end of the pressure vessel so that the pressure vessel can be removed from the retainer.

14. The gas dissolution assembly according to claim 13, further comprising a resilient member that tends to force the top cap out of engagement with the flexible seal.

15. The gas dissolution assembly according to claim 14, wherein the resilient member comprises a leaf spring having a first end connected to the retainer and a second end connected to the top cap.

16. The gas dissolution assembly according to claim 14, wherein the over-center clamping mechanism comprises a lever and a cam connected to the lever, wherein upon rotation of the lever about a pivot axis the cam cams the top cap onto the open end of the pressure vessel.

17. The gas dissolution assembly according to claim 15, wherein the cam comprises an eccentric outer surface that engages the top cap.

18. The gas dissolution assembly according to claim 15, wherein upon opposite rotation of the lever about the pivot axis allows the resilient member to force the top cap out of engagement with the flexible seal.

19. The gas dissolution assembly according to claim 15, further comprising a cross-shaft on the retainer and extending along the pivot axis, wherein the cam is supported on the cross-shaft.

20. The gas dissolution assembly according to claim 1, further comprising a housing, wherein the retainer is mounted in the housing.

21. A gas dissolution assembly comprising:
a pressure vessel having an open end and a being configured to contain a beverage; and
a closure mechanism for the pressure vessel, the closure mechanism comprising:
a top cap configured to couple with the open end of the pressure vessel; and
a clamping mechanism comprises a cam configured to rotate about a pivot axis;
wherein the rotation of the cam about the pivot axis in a first direction continuously cams the top cap towards the first end of the pressure vessel whereby the top cap couples to the open end; and
wherein opposite rotation of the cam about the pivot axis in a second direction continuously cams the top cap away from the open end of the pressure vessel whereby the top cap uncouples from the top end of the pressure vessel.

22. The gas dissolution assembly of claim 21, wherein the closure mechanism further comprises a lever coupled to the cam and being configured to rotate the cam about the pivot axis.

23. The gas dissolution assembly of claim 22, wherein the clamping mechanism is over-center of the pressure vessel.

24. The gas dissolution assembly of claim 21, the cam comprises a notch configured to stop rotation of the cam about a pivot axis.

25. The gas dissolution assembly of claim 24, further comprising a resilient member comprising a leaf spring and a retainer configured to receive the open end of the pressure vessel, the resilient member having a first end connected to the retainer and a second end connected to the top cap, wherein the resilient member tends to force the top cap out of engagement with the pressure vessel.
